(19) United States
(12) Patent Application Publication
(10) Pub. No.: US 2026/0084268 A1
(43) Pub. Date: Mar. 26, 2026

(54) WRENCH DEVICE FOR INSTALLATION AND REMOVAL OF THREADED CONNECTORS

(71) Applicant: BLUE ORIGIN, LLC, KENT, WA (US)

(72) Inventors: Mitchell Troublefield, Kent, WA (US); Derek Klopp, Kent, WA (US)

(21) Appl. No.: 18/898,249

(22) Filed: Sep. 26, 2024

(51) Int. Cl. B25B 13/08

(52) U.S. Cl. CPC B25B 13/08

(57) ABSTRACT

Systems and methods are directed toward torquing devices that can be used to install and remove threaded connectors. A wrench head can be used which includes a main body and two opposing teeth extending inwardly from the main body. The two opposing teeth can be positioned to receive corresponding grooves of a rotatable connector. A torque on the main body may be applied by the two opposing teeth to the two corresponding grooves of the rotatable connector, to engage or disengage the threaded connector with a threaded opening. The wrench head can be dimensioned to correspond with a 38999-type connector of a specific size.

### TECHNICAL FIELD

Developments disclosed and suggested herein relate generally to torquing tools that can be used to accurately apply high torque values to threaded connectors, and in particular to fixed distance spanners heads that include opposing pins sized to correspond with scalloped surfaces of D38999 Series III and Series IV type connectors.

### BACKGROUND

Threaded connectors are used in bulk across industries and therefore are often provided in standardized sizes and specifications. However, threaded connects can be required for use in harsh conditions not considered under standard speciation, including strong vibration, shock, moisture, wind, variable environments, or extreme temperatures, including aerospace, automotive, military, and marine applications. To ensure lasting security of threaded connectors, high torque values can be required for installation and corresponding removal. Additionally, high torque values can be required to be accurately and repeatedly applied without causing damaging to the surface gripped by the torquing tool. While torquing tools for connectors exist which can be used with threaded connectors, these tools generally do not allow for applying high torque without damaging the connector surface while providing a compact and robust form.

### SUMMARY

Disclosed herein are wrench tools, and similar torquing devices, which are able to be used to torque threaded connectors. Various embodiments may include configurations where a spanner tool includes a proximal end, a distal end, and a pair of prongs. The proximal end can have an interior surface and an exterior surface. The interior surface can define at least in part a span to accept a threaded connector. The distal end is connected to the exterior surface of the proximal end. The distal end is able to receive a force or torque to rotate the proximal end. The pair of prongs can be positioned at least partially on the interior surface. The pair of prongs can have opposing surfaces dimensioned to accept slotted surfaces of the threaded connector. The opposing surfaces can move together with the proximal end to rotate the threaded connector when in contact with the slotted surfaces.

Various embodiments may include wrench heads that each include a main body, a first tooth, and a second tooth. The first tooth can jut inwardly from the main body. The second tooth can jut inwardly from the main body across from the first tooth. The first tooth and the second tooth can be positioned to apply torque from the main body to two corresponding grooves of a rotatable connector.

Various embodiments allow for rotating of a threaded connector using a spanner device. A pair of slotted surfaces of a threaded connector can be received to a pair of corresponding opposing prongs within a span of a spanner device. The pair of opposing prongs can be dimensioned to engage the pair of slotted surfaces. A force can be applied to the spanner device to rotate the threaded connector using the prongs engaged with the slotted surface.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates a perspective view of a wrench head engaged with a threaded connector, in accordance with at least one embodiment;

FIG. 2 illustrates a cross-sectional view of a wrench head engaged with a threaded connector, in accordance with at least one embodiment;

FIG. 3 illustrates a detailed cross-sectional view of a prong of a wrench head engaged with a scalloped surface of a threaded connector, in accordance with at least one embodiment;

FIG. 4 illustrates a perspective view of an example wrench head dimensioned for a threaded connector, in accordance with at least one embodiment;

FIG. 5 illustrates a perspective view of another example wrench head dimensioned for a threaded connector, in accordance with at least one embodiment; and

FIG. 6 illustrates an example process that can be performed to rotate an threaded connector using a wrench head, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

As used herein, a connector may refer to a fastening device that may be used in cooperation with at least another device or body to create or separate from a secure attachment in response to rotational operation. The connector can be a threaded connector able to be secured with a threaded body, such as a connector ring or backshell able to couple with a counterpart connector receptacle. The connector can also be substantially circular or cylindrical and include one or more surfaces to interface with a tool to rotate the connector. The connector can be a 38999-style connector, such as a connector manufactured to a MIL-DTL 38999 or D38999 specification, including at least Series III and Series IV connectors. The connector may be available in multiple sizes, such as having multiple available diameters of the surface to interface with a tool to rotate the connector. The connector can be used to couple electrical or communication transfer systems, such as fiber optic, twinax, coax, quadrax, PC, or other systems, by providing one or more of signal, power, and data. The connector can include one or more surfaces or faces for interfacing with a user, tool, wrench, or wrench feature, such as teeth, pins, or prongs. The interfacing surfaces can include texture, such as knurls, and can also include smooth portions, such as scallops, grooves, flutes, flats, or slots. The complete coupling of the connector may be achieved with a number of turns, revolutions, or degrees, such as one 360-degree turn. The connector can be a portion of multi-part assembly, such as nut or bolt, electrical connector, paired rotary fastener, or other assembly.

As used herein, a wrench may refer to a torquing device, such as a wrench head or a spanner which is able to interface with a connector, such as by gripping a rotatable surface at contact points. The wrench can be used to rotate the connector, such as to install or remove the connector from another device or body. The wrench can include a first section such as a distal portion, shaft, or handle to receive a force or torque. The wrench can include a second section such as a proximal portion, head, or jaw to transfer the force or torque to a connector. The wrench may interface with a connector using limited contact area, such as two teeth. The wrench head can include a profile which includes an opening, void, or span to, at least partially, receive and contact the connector.

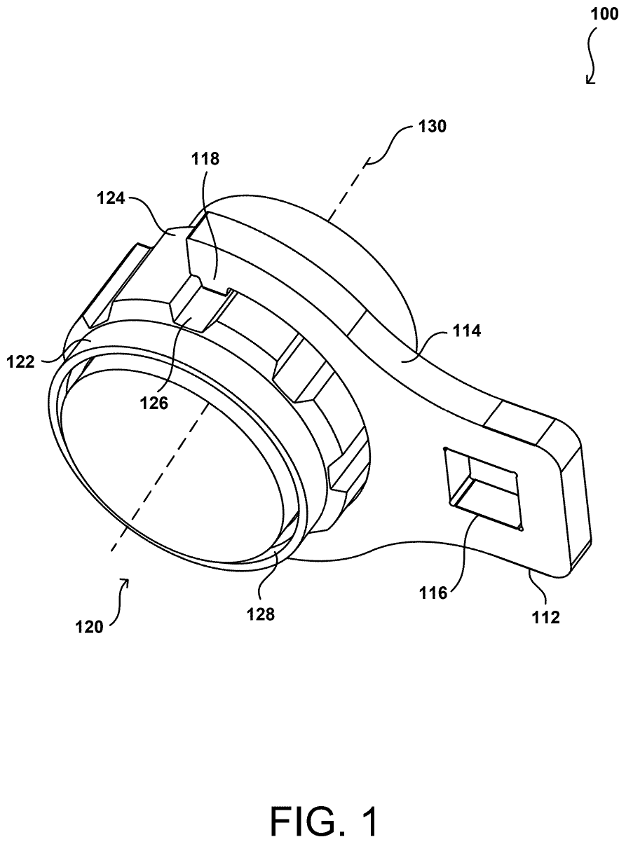

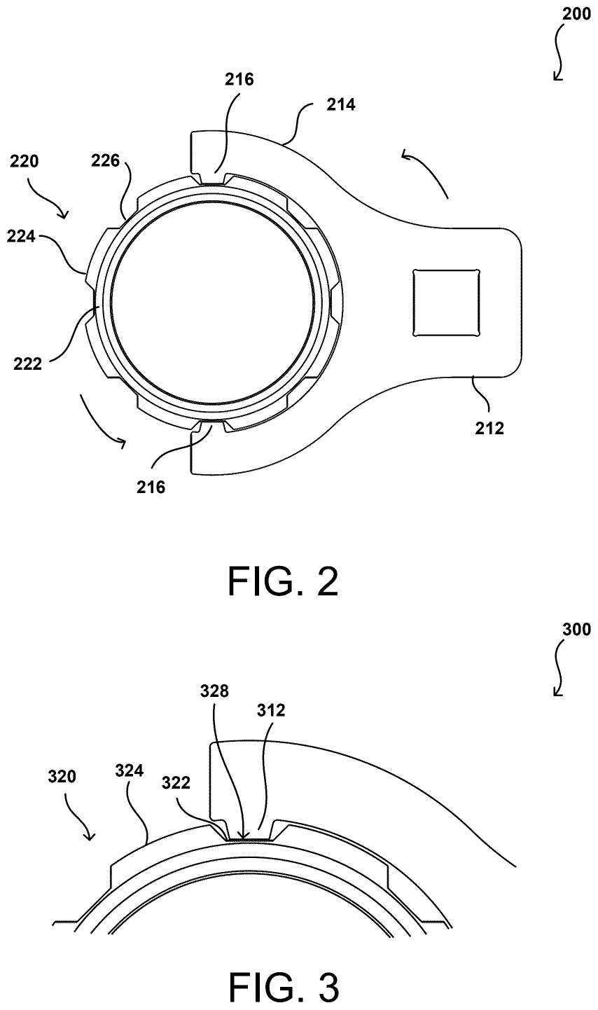

FIG. 1 illustrates a perspective view of a wrench head 100 engaged with a threaded connector 120 in accordance with at least one embodiment. As illustrated, the wrench head 100 includes a distal portion 112 and a proximal portion 114, which are typically formed from a metal, such as steel or stainless steel, and may have a compact size and shape. The distal portion 112 of the wrench head 100 may include a recess 116 to receive an extension, such as a handle, ratcheting mechanism, or other device, which can extend the length or orientation of the wrench head 100. The extension may be permanently integrated into the wrench head 100 or distal end 112. The extension may be able to increase leverage or change the orientation of the wrench head. The proximal portion 114 of the wrench head 100 may be connected to or extend from the distal portion 112. The proximal portion 114 may include two opposing prongs 118, as illustrated more clearly in FIG. 2. The two opposing prongs 118 may extend inwardly, from a surface of the wrench head 100, toward each other, and may form at least partially the profile of the opening to accept workpieces. The wrench head 100 may be a single-piece, or one-piece device, with no moving parts. The wrench head 100 may have a fixed jaw with the two prongs 118 unable to move relative to each other to remain the same distance apart. One or more portions or sections of the wrench head 100 may be increased in size, reduced in size, reinforced, strengthened, or otherwise modified in order to provide desired characteristics. For example, the width of the wrench head 100 may be minimized to provide a compact size for a low weight, such as about 0.188 inch in thickness, however the thickness may be from about 0.030 inch to about 0.250 inch, about 0.001 inch to about 0.030 inch, about 0.250 inch to about 1.000 inch, about 1.000 inches to about 5.000 inches, or other suitable thickness. The wrench head 100 may be required to fit through a gap between a backshell and a receptacle.

The threaded connector 120 may be a cylindrical electrical connector, that may be rotatably attached to a threaded receptacle. The connector 120 may include an outer surface 122 which includes a textured or knurled surface 124 and a scalloped surface 126 that may be used as contact points to induce rotation. The knurled surface 124 and the scalloped surface 126 of the outer surface 122 may be gripped by a user or tool, such as wrench head 100, to rotate the connector about an axis 130. The scalloped surface 126 of connector 120 may interface with prong 118 of the wrench head 100 and be used as the contact area for rotating the threaded connector with the wrench head 100. The connector 120 may include a set of threads 128 which mate with a set of threads of a receptacle. Rotation of the threaded connector around the axis 130 may cause the threads 128 to interface with the threads of the threaded receptacle, causing loosening or tightening of the connector. The threaded connector 120 may be positioned in contact with the wrench head 100 by moving the wrench head 100, relative to the threaded connector 120, linearly along the rotational axis 130 of a set of threads of the threaded connector, until the scalloped surface 126 are in contact with the prongs 118. The threaded connector 120 may be removed from contact with the wrench head 100 by moving the wrench head 100, relative to the threaded connector 120, linearly along the rotational axis 130 of a set of threads of the threaded connector, until the scalloped surface 126 are out of contact with the prongs 118.

As mentioned, scalloped surfaces of a connector may interface with prongs of a wrench head. FIG. 2 illustrates a cross-sectional view demonstrating the rotational interface capability of a wrench head 200 with a connector 220 in accordance with at least one embodiment. It should be understood that due to the nature of FIG. 2, the wrench head 200 and the connector 220 are shown to rotate in a counterclockwise direction, but the rotation can also be in a clockwise direction. As shown in FIG. 2, the wrench head 200 may be engaged with the threaded connector 220, in accordance with at least one embodiment. The force applied to a distal end 212 of the wrench head 200 may be transferred to a proximal end 214 of the wrench head 200, which would cause counterclockwise rotation. A pair of prongs 216 extending inwardly from the proximal end 214 of the wrench head 200 may include one or more surfaces that are able to interface with the connector 220. The connector 220 may include an outer surface 222 which has a plurality of knurled surfaces 224 and a plurality of scalloped surfaces 226. The prongs 216 may be size, shaped, positioned, and/or dimensioned to engage the scalloped surfaces 226 to provide friction as contact points. As the force is applied to the wrench head 200, the prongs 216 may grip the scalloped surfaces 226, providing a torque and twisting the connector 220 counterclockwise. The connector 220 may first be hand-tightened, and then fully tightened on the threaded receptacle using the wrench head 200. The connector 220 may be first loosened using the wrench head 200, and then fully removed from the threaded receptacle by hand. The prongs 216 may be able to apply high torque values to the connector 220, such as up to at least 180 inch-pounds, 300 inch-pounds, 500 inch-pounds, or other suitable amounts.

As mentioned, scalloped surfaces of a connector may interface with prongs of a wrench head. FIG. 3 illustrates a detailed cross-sectional view a wrench head 300 including a prong 312 and a connector 320 including a scalloped surface 322, the prong 312 engaged with the scalloped surface 322 at a contact area 328 in accordance with at least one embodiment. At least a portion of the prong 312 may be formed to correspond as closely as possible to at least a portion of the scalloped surface 322. In an example, the prong 312 may include a flat surface that is substantially similar to a flat surface of the scalloped surface 322, where the flat surfaces for a contact area 328 for the wrench head 300 and the connector 320 may engage. The prong 312 may be formed to prevent engagement with a knurled surfaces 324 of the connector 320. The tapered surfaced may improve the interfacing process and provide a better fit with the scalloped surfaces 322 between the knurled surfaces 324. The prong 312 may be formed to minimize gouging or other damage to the connector 320 and may be formed to reduce slippage between the wrench head 300 and the connector 320. The wrench head 300 may have more than two prongs 312 to interface with the connectors, such as three, four, or five prongs 312 which are positioned to interface with more scalloped surfaces 322 of the connector 320. The prongs 312 may include tapered surfaces extending from a proximal end to the scalloped surface 322 of the connector 320. The prongs 312 can be positioned apart by about 180 degrees or may be positioned about by less than 180 degrees, such as about 90 degrees, about 135 degrees, or other suitable angles.

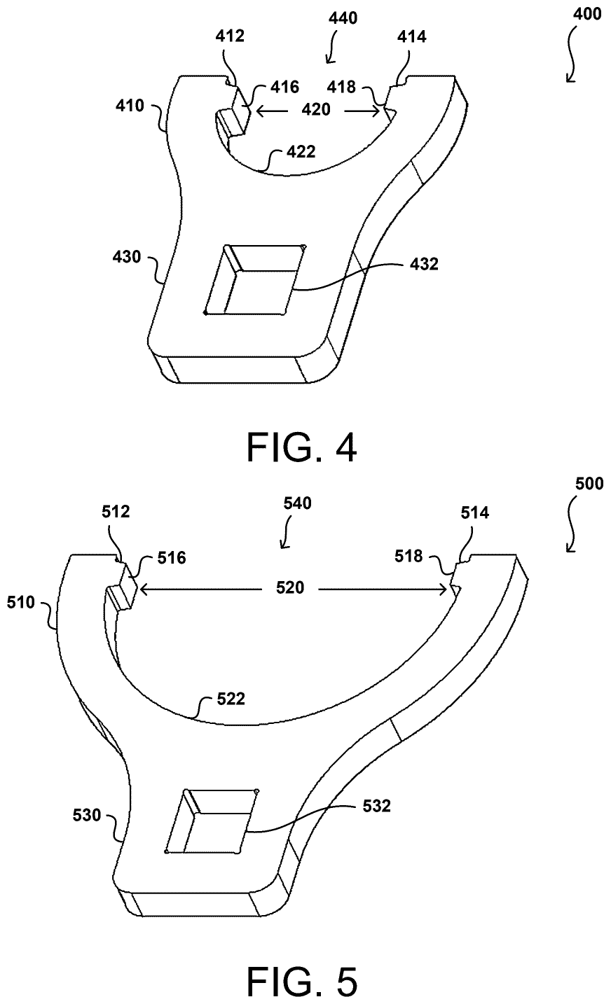

Approaches in accordance with various embodiments provide for the use of a spanner tool or similar torquing device which are dimensioned according to specific connector sizes. FIG. 4 illustrates a perspective view of a spanner tool 400 that can be used in accordance with at least one embodiment. The spanner tool 400 may be dimensioned to be used with a specific size threaded connector. As shown in FIG. 4, the spanner tool 400 may have a distal end 430 and a proximal end 410. The distal end 430 may have a recess 432 to accept a removable handle or ratchet input. The proximal end 410 may include a first tooth 412 and a second tooth 414 jutting inwardly across from the other tooth. The first tooth 412 may have a first tooth surface 416 to engage with a flat or substantially flat groove of a backshell of a rotatable connector. The second tooth 414 may have a second tooth surface 418 to engage with another flat or substantially flat groove of a threaded connector. The first tooth surface 416 and the second tooth surface 418 may be parallel or substantially parallel, in order to interface with the grooves of the connector. The first tooth surface 416 and the second tooth surface 418 may be flat, partially curved, or completely curved, such as concave or convex, in order to interface with the grooves of the connector.

The proximal end 410 may include an open end 440 defined by at least an inner surface of the proximal end 410. The open end 440 may be at least partially defined by an exterior surface of the proximal end 410. The open end 440 may be adjacent to the first tooth 412 and the second tooth 414. The open area of the open end 440 may be substantially smaller than a closed area of the spanner tool 400, such as less than a quarter of the area, and the spanner tool 400 may not have an open end 440. A distance 420 between the first tooth surface 416 and the second tooth surface 418 may be sized to accept a specific size connector. For example, the spanner tool 400 may have the distance 420 sized to accept, to the first tooth surface 416 and the second tooth surface 418, opposing flat or substantially flat grooves of a 38999 Series III connector with a shell size of one of 09, 11, 13, 15, 17, 19, 21, 23, or 25. A set of nine of the spanner tools 400 may be needed to correspond with the nine sizes of 38999 Series III connectors. Additionally, a radius 422 of the spanner tool 400 may be sized to prevent interference with the connector during at least part of the operation of the spanner tool 400. One or more portions of the proximal end 410 of the spanner tool 400, such as the portions extending from the distal end 430 to the first tooth 412 and the second tooth 414 may have a reduced size, such as to prevent interference with a connector or provide a more compact device to prevent interference with other objects in a work area.

FIG. 5 illustrates a perspective view of another spanner tool 500 that can be used in accordance with at least one embodiment. In an example, the spanner tool 400 of FIG. 4 may be dimensioned to be used with a threaded connector having a smaller diameter and the spanner tool 500 may be dimensioned to be used with a threaded connector having a larger diameter. The spanner tool 500 may have a distal end 530 and a proximal end 510. The distal end 530 may have a recess or cutout 532 to accept a removable handle or ratchet input. The proximal end 510 may include a first tooth 512 and a second tooth 514 jutting inwardly across from the other tooth. The first tooth 512 may have a first tooth surface 516 to engage with a groove of a backshell of a rotatable connector. The second tooth 514 may have a second tooth surface 518 to engage with another groove of a threaded connector. The first tooth surface 516 and the second tooth surface 518 may be parallel or substantially parallel, in order to interface with the grooves of the connector. The proximal end 510 may include an open end 540 defined by at least an inner surface of the proximal end 510. The open end 540 may be at least partially defined by an exterior surface of the proximal end 510. The open end 540 may be adjacent to the first tooth 512 and the second tooth 514. A distance 520 between the first tooth surface 516 and the second tooth surface 518 may be sized to accept a specific size connector that is larger than the connector for which the distance 420 of the spanner tool 400 is sized. For example, the spanner tool 500 may have the distance 520 sized to accept, to first tooth surface 516 and the second tooth surface 518, opposing grooves of a 38999 Series III connector with a shell size 11, while the distance 420 is sized to accept a 38999 Series III connector with a shell size 09. The spanner tool 500 may be dimensioned for use with any other threaded circular connector of a specific size. Additionally, a radius 522 of the spanner tool 500 may be sized to prevent interference with the threaded connector during at least part of the operation of the spanner tool 500. For example, while the spanner tool 500 is engaged with a connector and extends perpendicular to a rotational axis of the connector, the radius 522 may not contact the connector, however, when the spanner tool 500 tilted at an angle away from perpendicular to the rotational axis of the connector, the radius 522 may contact the connector.

The spanner tool 500 may include a soft jaw which uses a material, such as silicone, plastic, vinyl, brass, or other suitable material, to cover at least a portion of the first tooth 512 and the second tooth 514. Other portions or parts of the spanner tool 500 may include metals, such as steel. The soft jaw may be removable or may be permanently affixed to the spanner tool 500. The use of the soft jaw for the spanner tool 500 may increase the friction and/or reduce slippage between the spanner tool 500 and the connector, and may reduce marring, gouging, or damage to the connector. One or more portions of the spanner tool 500 may be manufactured by milling, sheet cutting, including water jet and laser cutting, electrical discharge machining, or other suitable methods.

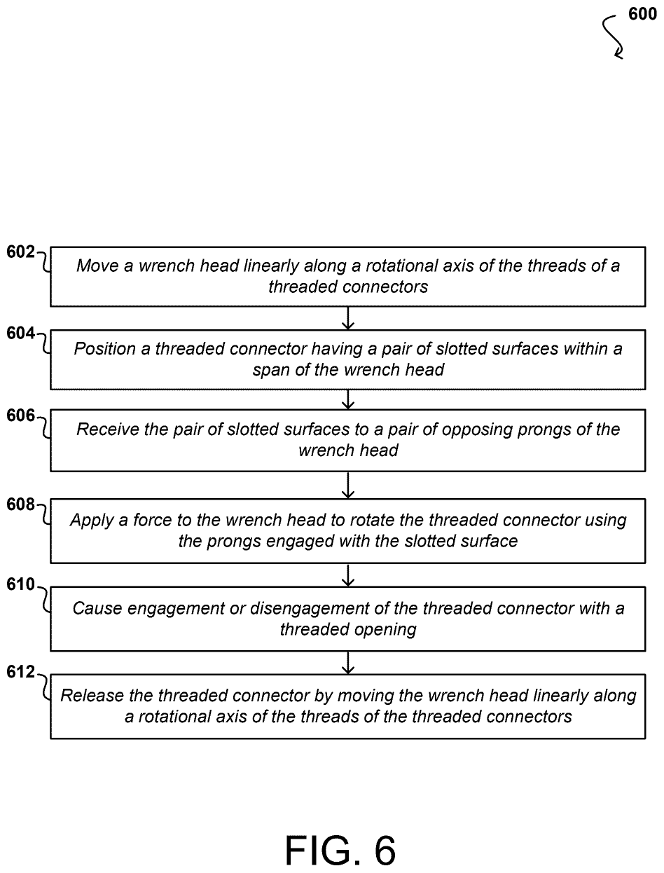

FIG. 6 illustrates an example process 600 to rotate a threaded connector using a wrench head in accordance with various embodiments. It should be understood that for this and other processes presented herein that there may be additional, fewer, or alternative operations performed in similar or alternative orders, or at least partially in parallel, within the scope of the various embodiments unless otherwise specifically stated. A wrench head can be moved 602 linearly along a rotational axis of the threads of a threaded connector. A handle can be removably attached to a distal portion of the wrench head, opposite of a proximal portion including a jaw. The wrench head can have a fixed jaw and be sized to receive a specific connector size. The connector may be a 38999-type electrical connector. A threaded connector having a pair of slotted surfaces may be positioned 604 within an opening of the wrench head. The opening may be defined by the profile of the wrench head. The slotted surfaces may be formed by scallops into the surface of the connector. The pair of slotted surfaces can be received 606 to a pair of opposing prongs to the wrench head. The prongs can extend from an internal surface of the wrench head into the open span. The prongs can be dimensioned to correspond with the slotted surfaces and enable the application of torque from the wrench head to the threaded connector. The slotted surface can be depressed within the threaded connector, into which the prongs enter. The pair of opposing prongs can be positioned apart by about 180 degrees, or less than 180 degrees.

A force can be applied 608 to the wrench head to rotate the threaded connector using the prongs engaged with the slotted surfaces. The force can be applied from a handle, such as a ratcheting handle, and transferred through the pair of prongs to the slotted surfaces of the threaded connector. The pair of prongs may be able to transfer the torque to turn the connector without marring or damaging the surface of the connector. The threaded connector can be caused 610 to be engaged or disengaged with a threaded opening. The rotation provided by the wrench head may cause the threads of the threaded connector and the threads of the threaded body to cooperate. For example, a clockwise rotation may cause engagement, until the connection is fully secure, and a counterclockwise or anticlockwise rotation may cause disengagement, until the connection is fully released. In another example, the converse can be enabled. The threaded connector may be released 612 by moving the wrench head linearly along a rotational axis of the threads of the threaded connectors. The pair of prongs of the wrench head may release from the slotted surfaces of the threaded connector. The distance between the pair of prong may be sized and shaped to release from the slotted surfaces.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Terms such as “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description, and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A spanner tool, comprising:
a proximal end having an interior surface and an exterior surface, wherein the interior surface defines at least in part a span to accept a threaded connector;
a distal end connected to the exterior surface of the proximal end, wherein the distal end is able to receive a force to rotate the proximal end; and
a pair of prongs positioned at least partially on the interior surface and having opposing surfaces dimensioned to accept slotted surfaces of the threaded connector, the opposing surfaces to move together with the proximal end to rotate the threaded connector when in contact with the slotted surfaces.

2. The spanner tool of claim 1, wherein the threaded connector is a D38999 electrical connector.

3. The spanner tool of claim 1, wherein the interior surface and the exterior surface define an open end of the proximal end.

4. The spanner tool of claim 1, wherein the proximal end includes a fixed jaw.

5. The spanner tool of claim 1, wherein the distal end is able to receive a removable ratcheting handle.

6. The spanner tool of claim 1, wherein the opposing surfaces of the pair of prongs are positioned 180 degrees apart.

7. The spanner tool of claim 1, wherein the opposing surfaces of the pair of prongs are at least partially comprised of a material softer than the slotted surfaces of the threaded connector.

8. The spanner tool of claim 7, wherein the material is potentially removable.

9. A wrench head, comprising:
a main body;
a first tooth jutting inwardly from the main body; and
a second tooth jutting inwardly from the main body across from the first tooth, the first tooth and second tooth positioned to apply torque, in response to a rotation of the main body, to two corresponding grooves of a rotatable connector.

10. The wrench head of claim 9, wherein the rotatable connector is a 38999 Series III or Series IV connector.

11. The wrench head of claim 9, wherein the main body includes an open end.

12. The wrench head of claim 9, wherein the first tooth and the second tooth are separated by a fixed distance.

13. The wrench head of claim 9, wherein the main body is able to receive a handle.

14. The wrench head of claim 9, wherein the main body, the first tooth, and the second tooth are a single piece.

15. The wrench head of claim 9, wherein at least one of the first tooth or the second tooth include a covering comprised of a material softer than the corresponding grooves of the rotatable connector.

16. The wrench head of claim 15, wherein the material is potentially removable.

17. A method, comprising:
receiving a pair of slotted surfaces, of a threaded connector, to a pair of corresponding opposing prongs within a span of a spanner device, the pair of opposing prongs dimensioned to engage the pair of slotted surfaces; and
applying a force to the spanner device to rotate the threaded connector using the prongs engaged with the pair of slotted surfaces.

18. The method of claim 17, further comprising:
positioning the threaded connector at a threaded opening before applying a force to the spanner device.

19. The method of claim 17, wherein rotation of the threaded connector causes engagement or disengagement of the threaded connector with a threaded opening.

20. The method of claim 17, wherein receiving the pair of slotted surfaces further comprises:
moving the spanner device, relative to the threaded connector, linearly along a rotational axis of a set of threads of the threaded connector.
